(19) United States
(12) Patent Application Publication
(10) Pub. No.: US 2004/0187259 A1
(43) Pub. Date: Sep. 30, 2004

(54) Hinge apparatus

(76) Inventor: Byoung-Hee Suh, Dongrae-Ku Pusan-City (KR)

Correspondence Address: Song K Jung, McKenna Long & Aldridge, Attorneys at Law, 1900 K Street N W, Washington, DC, 20006, US

(21) Appl. No.: 10/221,738

(22) PCT Filed: Sep. 27, 2001
(86) PCT No.: PCT/KR01/01622

(30) Foreign Application Priority Data
Jan. 17, 2001 (KR) 2001/1220 U

(51) Int. Cl. E05D 1/00

(52) U.S. Cl. 16/227

(57) ABSTRACT

The present invention relates to a hinge appartus using an engagement structure between a rotating cam, and solves problems of a conventional hinge apparatus that the assembility has been deteriorated and the manufacture costs have been increased, by reducing the number of parts and improving their structures compared with the conventional hinge apparatus. Such a hinge apparatus has an advantage in that the number of parts can be reduced by allowing the rotation cam to be secured to the shaft by forming the engagement protrusions at the one longitudinal end of the shaft and forming the engagement passages and the engagement grooves in the rotating cam. Furthermore, the hinge apparatus according to the present invention has further advantages in that since the number of parts is reduced, the number of assembly processes can be reduced, and the unit cost and then the manufacture costs can be lowered.

### TECHNICAL FIELD

The present invention relates to a hinge apparatus for use in a cover opening and closing structure for a variety of electronic products, such as a cellular phone, a notebook computer, a personal digital assistant (PDA), and the like, and more particularly to a hinge apparatus wherein the number of parts can be reduced and the assembility can be enhanced by improving assembly of the hinge apparatus using an engagement structure between a secured cam and a rotating cam.

A hinge apparatus is not limited in its application but widely used in various applications. Modified hinge apparatus have been developed to meet the requirements for the respective applications. In recent, the hinge apparatus, which is used in electronic products having relatively small sizes, such as a cellular phone, a notebook computer, a PDA, and the like, requires characteristics by which opened and closed positions of a cover can be secured at arbitrary angles and the cover can be firmly closed or opened. Thus, the hinge apparatus using the engagement structure between the rotating cam and the secured cam has been developed, and is now widely used in a cellular phone, a notebook computer, and the like.

### BACKGROUND ART

Referring to FIG. 1, a rotating cam 11 is connected with a cover 1 of a cellular phone and interlocks with the cover 1 upon opening and closing of the cover 1, while a secured cam 13 is connected with a body 3 of the cellular phone and remains in a secured state irrespective of any motion of the rotating cam 11. The rotating cam 11 and the secured cam 13 are normally engaged with each other at their peak portions 11a, 13b and valley portions 11b, 13a as shown in FIG. 2. A spring 17 urges the secured cam 13 using its own elasticity so that the rotating cam 11 and the secured cam 13 can be firmly engaged with each other without any gap therebetween, and a sliding ring 15 is inserted between the secured cam 13 and the spring 17 so that friction between the spring 17 and the secured cam 13 can be minimized, resulting in prevention of wear and smooth sliding action of the secured cam 13. A flange 21 prevents the spring 17 from being pushed rearward due to any reaction occurring as the spring 17 urges the secured cam 13, and an engagement ring 23 and an E-shaped ring 25 secure the flange 21 to a shaft 19 so that the flange cannot be pushed rearward by the spring 17. Since the rotating cam 11 is engaged with an engagement jaw 19a of the shaft 19 so that it cannot be pushed forward and the flange 21 cannot be pushed rearward by the engagement ring 23 and the E-shaped ring 25, the secured cam 13 and the sliding ring 15 are urged by the restoring force of the spring 17 between the rotating cam 11 and the flange 21. Consequently, the rotating cam 11 and the secured cam 13 comes in firm contact with each other by means of the elasticity of the spring 17.

In a state shown in FIG. 3, as the cover 1 of the cellular phone is opened, the rotating cam 11 connected to the cover 1 also rotates. The rotating cam 11 then moves along the edge of the secured cam 13 in which the peak portions 13b and the valley portions 13a are formed. Thus, the rotating cam 11 and the secured cam 13 are spaced apart from each other. Here, since the rotating cam 11 is secured to the shaft 17, it cannot be pushed forward. Accordingly, the secured cam 13 is pushed rearward. However, since the spring 17 urges the secured cam 13 forward, the rotating cam 11 and the secured cam 13 continue to remain in an urged state. Thus, the cover 1 of the cellular phone can be firmly opened and closed.

In the related industries, the peak portions 11a, 13b and the valley portions 11b, 13a of the rotating cam 11 and the secured cam 13, and the shaft 17 have been properly configured such that the rotating cam 11 can be stopped at arbitrary angles with respect to the secured cam 13. Thus, the cover can be firmly secured at the arbitrary angles.

In the aforementioned hinge apparatus shown in FIG. 2, the number of parts is eight, the rotating cam 11 is engaged with the engagement jaw 19a of the shaft 19, and the flange 21, the engagement ring 23 and the E-shaped ring 25 are engaged with the shaft 19 so that the spring 17 cannot escape from the shaft 19. The hinge apparatus shown in FIG. 2 has problems in that since the number of parts is as large as eight, the number of assembly processes is large, the assembly process is complicated, and the manufacture costs are increased.

In order to solve the above problems, attempts to reduce the number of parts have been made. FIG. 4 shows another example of a conventional hinge apparatus wherein the number of parts can be reduced and the unit cost can be lowered by improving assembly of the hinge apparatus of FIG. 2. Referring to FIG. 4, a secured cam 33 is engaged with a rotating cam 31, and a spring 37 is fitted over a rear end of the secured cam 33. A spacer 35 is then inserted into a trailing end of the spring, and a shaft 39 passes through the rotating cam 31, the secured cam 33, the spring 37 and the spacer 35. An engagement piece 39a taking the shape of a longitudinal half of a cylinder is formed at one end of the shaft 39, while a flange 39b is formed at the other end of the shaft 39. A securing bore 39c is formed vertically in the engagement piece 39a. In the meantime, a semi-cylindrical engagement bore 31a is formed in the rotating cam 31 for allowing the engagement piece 39a of the shaft 39 to be inserted thereinto, and a securing bore 31b is also formed in the rotating cam to vertically penetrate through the engagement bore 31a. A securing pin 41 is inserted into the securing bore 31b.

FIG. 5 shows the hinge apparatus of FIG. 4 in an assembled state. Referring to FIG. 5, the engagement piece 39a of the shaft 39 is inserted into the engagement bore 31a of the rotating cam 31, and the securing pin 41 is inserted through the securing bore 39c of the shaft 39 and the securing bore 31b of the rotating cam 31.

The secured cam 33 is then engaged and assembled with the rotating cam 31, and they are elastically supported by the spring 37. Since the rotating cam 31 is secured to the shaft 39 by the securing pin 41, it is still secured to the shaft 39 even if the elastic force of the spring 37 is acted thereon. In the mean time, the spring 37 cannot be pushed rearward by the spacer 35 and the flange 39b of the shaft 39.

Since the flange 39b is formed integrally with and at the other end of the shaft 39 in the hinge apparatus of FIG. 4 or 5, there is no need for the engagement ring 23, the E-shaped ring 25, and the like contrary to the hinge apparatus of FIG. 2. Thus, the number of parts is entirely reduced from eight in the hinge apparatus of FIG. 2 to six in the hinge apparatus of FIG. 4. There are advantages in that since the number of parts is reduced, the assembly becomes simple and the manufacture costs are lowered.

Although the number of parts has been reduced with the development of the hinge apparatus of FIG. 5 compared with the previous hinge apparatus, there still exists a need for further reduction of the number of parts for lowering the manufacture costs.

### DISCLOSURE OF INVENTION

Therefore, an object of the present invention is to provide a hinge apparatus wherein the number of entire parts can be reduced, the assembility is enhanced and the manufacture costs can be minimized by improving assembly of a rotating cam and a shaft.

According to the present invention for achieving the above object, there is provided a hinge apparatus using interaction between a rotating cam with peak portions and valley portions formed therein, and a secured cam formed to be engaged with the rotating cam, comprising a shaft having a flange formed at one longitudinal end thereof and engagement protrusions formed to protrude from the circumference of the shaft at the other longitudinal end thereof; the rotating cam having a hollow for allowing penetration of the shaft therethrough, engagement passages formed in the hollow for allowing the engagement protrusions to pass through the engagement passages upon insertion of the shaft into the hollow, and engagement grooves formed at an angle with respect to the engagement passages so that the engagement protrusions of the inserted shaft can be seated therein; the secured cam being constructed to be engaged with the rotating cam and having a hollow and engagement passages formed to allow the shaft and the engagement protrusions to pass therethrough; and a spring formed at a trailing end of the secured cam for exerting force so that the rotating cam and the secured cam can be firmly engaged with each other.

Furthermore, the flange of the shaft is formed with a recess for an assembly tool for adapting to assembly automation upon securing of the rotating cam to the shaft and for allowing the assembly tool to be inserted thereinto for facilitating rotation of the shaft.

The hinge apparatus according to the present invention constructed as such has advantages in that the number of parts can be greatly reduced, the assembility can be enhanced, and the manufacture costs can be lowered.

### BRIEF DESCRIPTION OF DRAWINGS

FIG. 1 is a perspective view showing one example of a conventional hinge apparatus for use in a cover opening and closing structure for a cellular phone.

FIG. 2 is an exploded perspective view of the conventional hinge apparatus.

FIG. 3 is a perspective view showing the hinge apparatus of FIG. 2 in an assembled state.

FIG. 4 is an exploded perspective view of another example of the conventional hinge apparatus.

FIG. 5 is a perspective view showing the hinge apparatus of FIG. 4 in an assembled state.

FIG. 6 is an exploded perspective view of a hinge apparatus according to one embodiment of the present invention.

FIG. 7 is a perspective view showing the hinge apparatus of FIG. 6 in an assembled state.

FIG. 8 is a perspective view showing the operation of the hinge apparatus of FIG. 6.

FIGS. 9(a) and (b) show other embodiments of a flange of a shaft of the hinge apparatus shown in FIG. 6.

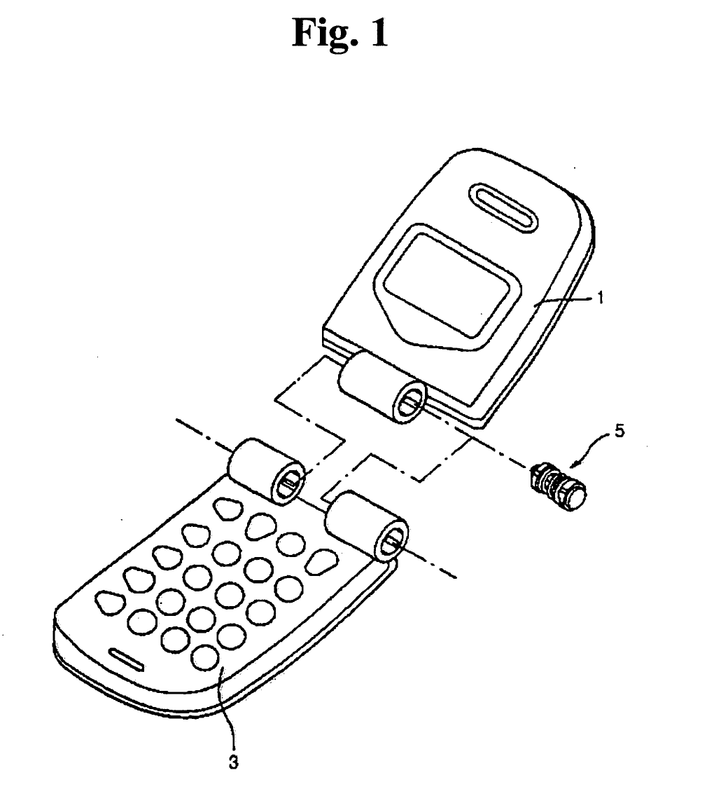

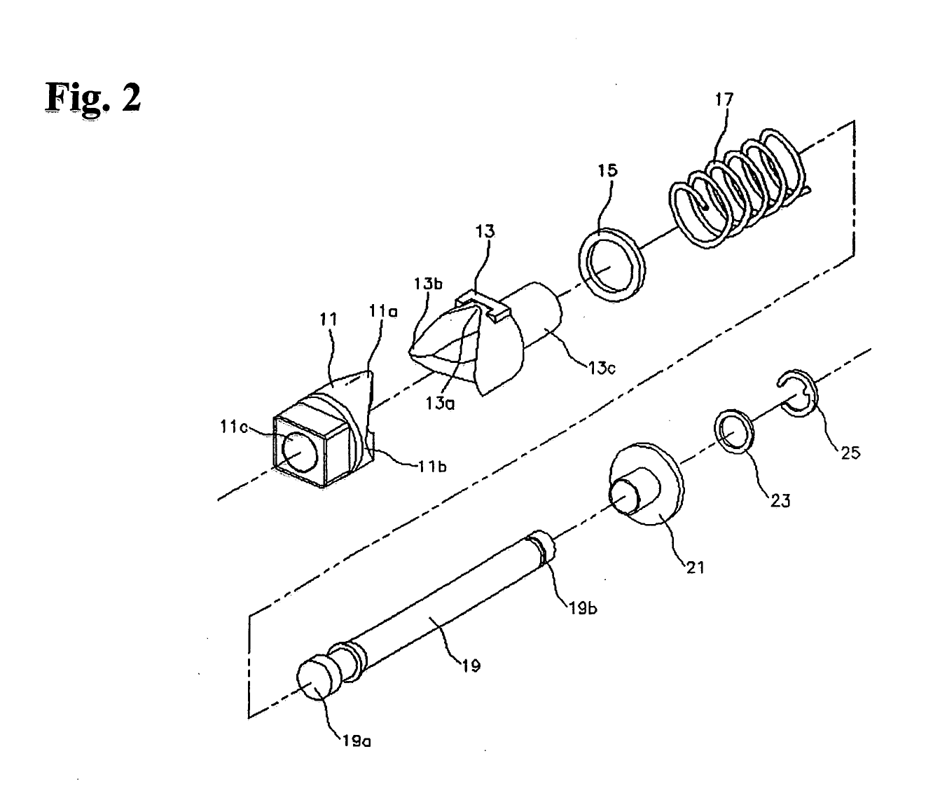

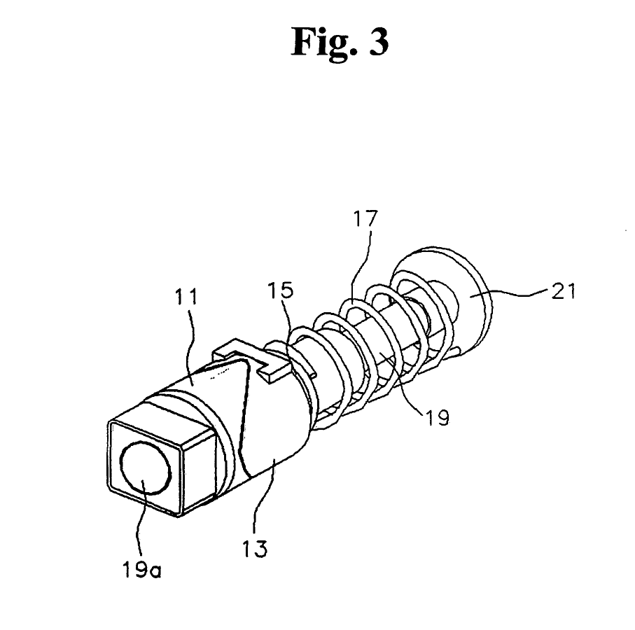

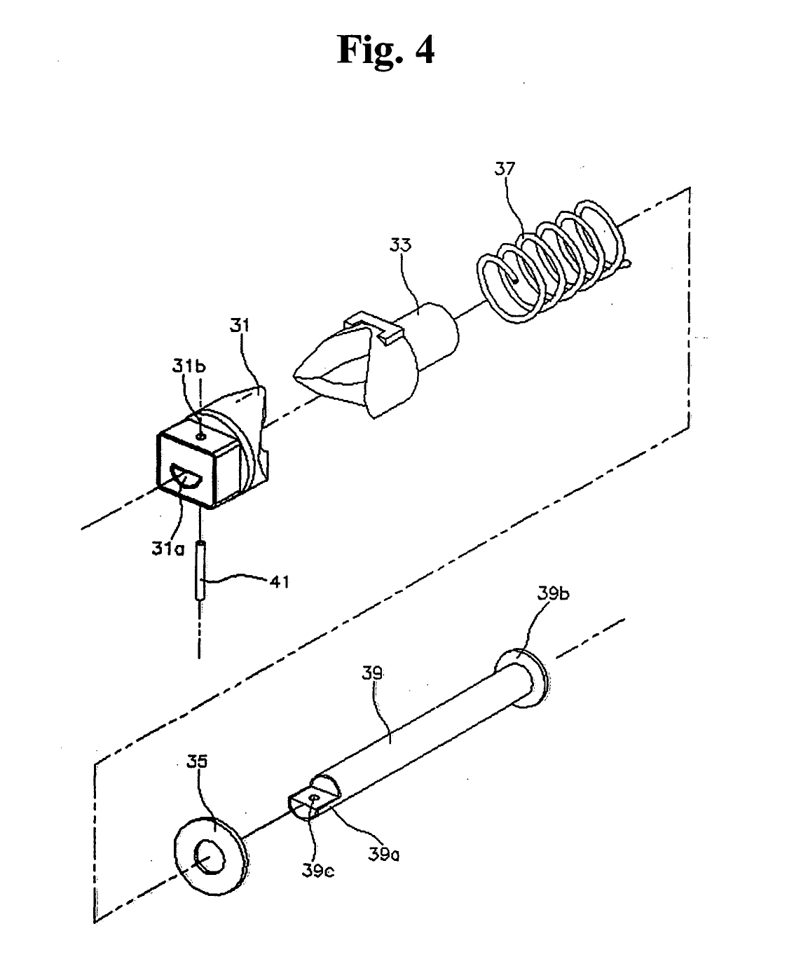

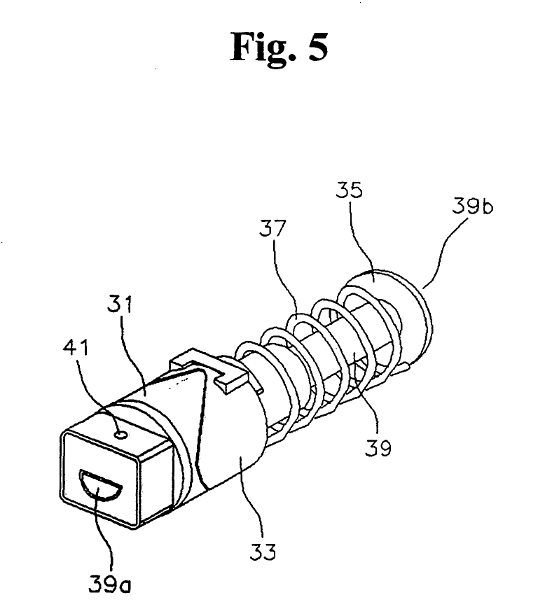

### BEST MODE FOR CARRYING OUT THE INVENTION

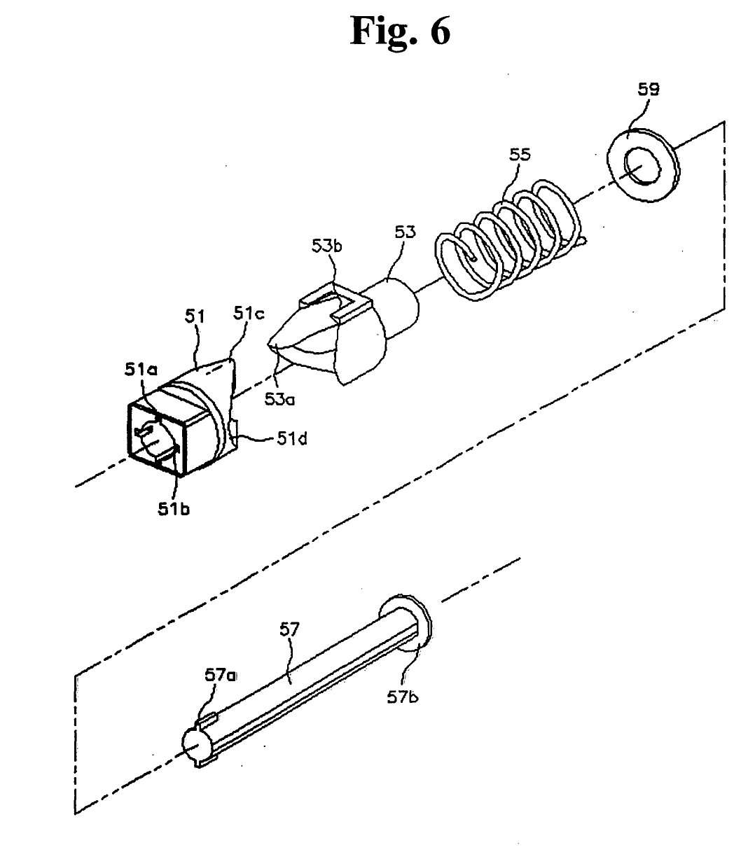

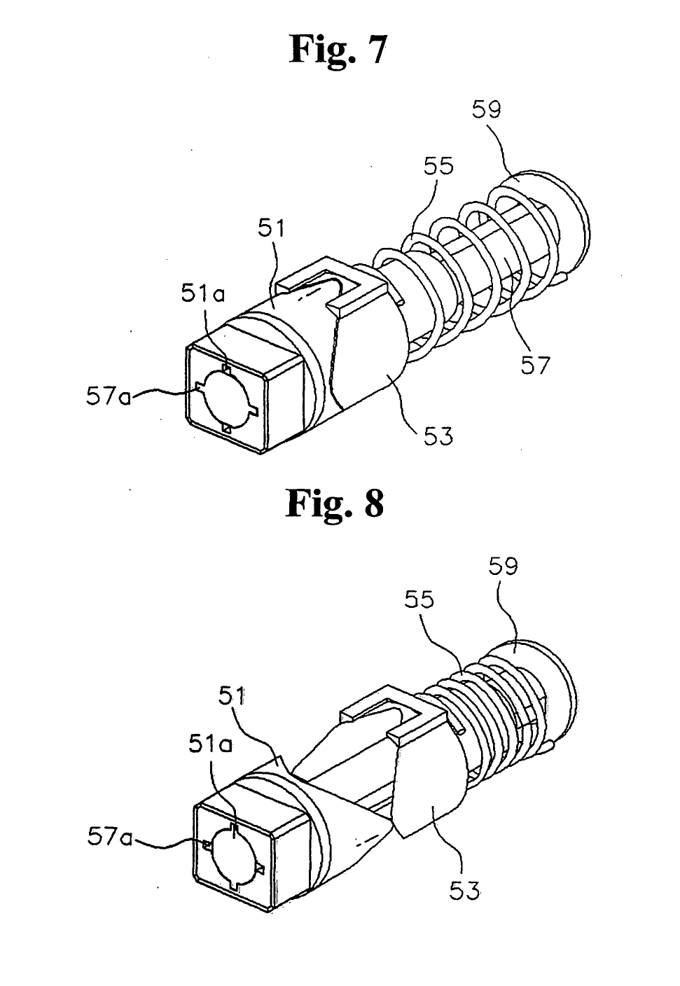

Hereinafter, the constitution of a hinge apparatus according to the present invention will be described in detail with reference to the accompanying drawings. FIG. 6 is an exploded perspective view of a hinge apparatus according to one embodiment of the present invention; and FIG. 7 is a perspective view showing the hinge apparatus of FIG. 6 in an assembled state.

Referring to FIGS. 6 and 7, the hinge apparatus of this embodiment comprises a rotating cam 51 having a hollow, engagement passages 51a formed at top and bottom sides of the hollow, engagement grooves 51b formed at left and right sides of the hollow perpendicularly to the engagement passages 51a at a longitudinal end thereof, and peak portions 51c and valley portions 51d formed at the other longitudinal end thereof; a secured cam 53 having peak portions 53a and valley portions 53b formed to be engaged with the peak and valley portions of the rotating cam 51 at one side thereof and a hollow cylindrical column formed at the other side thereof; a spring 55 engaged with a trailing end of the secured cam 53; a cylindrical shaft 57 having slightly planar portions at both sides for allowing its penetration through the hollows of the rotating cam 51 and the secured cam, engagement protrusions 57a formed at top and bottom sides of a longitudinal end of the shaft to be engaged with the engagement grooves 51b of the rotating cam 51, and a flange 57b formed at the other longitudinal end of the shaft for preventing the spring 55 from escaping therefrom; and a spacer 59 interposed between the spring and the flange of the shaft.

Upon assembly of the respective parts from a state shown in FIG. 6, the spacer 59 is fitted over the shaft 57. The spring 55 is then fitted over the shaft so that one side of the spring 55 comes in contact with the spacer 59. This embodiment is constructed such that the spacer 59 is interposed between the spring 55 and the shaft 57. This is to consider the workability and economical efficiency of the shaft 57. However, the spacer 59 may be omitted contrary to this embodiment, if desired.

Next, the one end of the shaft 57 is inserted into the hollow of the secured cam 53 so that the secured cam 53 can be positioned at a leading end of the spring 55.

The hollow is formed in the secured cam 53 for allowing the shaft 57 to be inserted thereinto, and engagement passages are formed at top and bottom sides of the hollow of the secured cam 53, in the same manner as the rotating cam 51. The engagement passages of the secured cam 53 is formed at the top and bottom sides of the hollow for allowing the engagement protrusions 57a of the shaft 57 to be introduced thereinto. That is, when the shaft 57 is inserted into the secured cam 53, the engagement protrusions 57a of the shaft 57 are appropriately positioned to be aligned with the engagement passages of the secured cam 53, and the shaft 57 is then inserted into the hollow of the secured cam 53.

After inserted into the secured cam 53, the shaft 57 is inserted into the rotating cam 51 so that the rotating cam can be positioned at the leading end of the secured cam 53.

The rotating cam 51 is formed with the hollow, the engagement passages 51 a are formed at the top and bottom sides of the hollow for allowing the engagement protrusions 57a of the shaft 57 to be introduced thereinto in the same manner as the secured cam 53, and the engagement grooves 51b are formed perpendicularly to the engagement passages 51a on a side opposite to a side at which the peak portions 51c and the valley portions 51d are formed.

The engagement grooves 51b are constructed such that the engagement protrusions 57a of the shaft 57 are seated therein. That is, by inserting the shaft 57 of which the engagement protrusions 57a are introduced along the engagement passages 51a into the rotating cam 51 and then rotating the shaft 57 by 90° in the clockwise or counterclockwise direction, the engagement protrusions 57a are seated in the engagement grooves 51b. Since the engagement protrusions 57a of the shaft 57 are seated in the engagement grooves 51b, the rotating cam 51 is engaged with the shaft 57 not to escape from the shaft 57.

The rotating cam 51 and the secured cam 53 are urged forward by the elastic force of the spring 55. However, since the engagement protrusions 57a of the shaft 57 are seated in the engagement grooves 51b of the rotating cam 51, the rotating cam 51 cannot escape from the shaft 57.

In the meantime, since the spring 55 cannot be pushed rearward by the flange 57b of the shaft 57 and the spacer 59, the spring 55, the rotating cam 51 and the secured cam 53 are coupled with the shaft 57.

Since the detailed description of the operation of the hinge apparatus is the same as that of the conventional hinge apparatus, it will be omitted. As the cover is opened, the rotating cam 51 is rotated. Then, the rotating cam 51 and the secured cam 53 are spaced apart from each other, and the spring 55 is compressed, as shown in FIG. 8. Since the compressed spring 55 tends to return to the original state, it thus continues to urge the secured cam 53.

In this embodiment, the engagement protrusions 57a are formed at the one longitudinal end of the shaft 57, and the engagement passages 51a for allowing the engagement protrusions 57a to be introduced thereinto and the engagement grooves 51b for allowing the engagement protrusions 57a to be seated therein are formed in the rotating cam 51. Accordingly, the hinge apparatus has an advantage in that since there is no need for the securing pin 14, the E-shaped ring 25, and the like which have been used to secure the rotating cam 51 to the shaft 57 in the conventional hinge apparatus, the number of the parts can be greatly reduced to four or five as shown in FIG. 6.

Furthermore, in this embodiment, the shaft is formed in the cylindrical shape with the planar portions at both sides thereof. Since this is to enhance the workability of the shaft, the shaft may be formed in a simple cylindrical shape contrary to this embodiment.

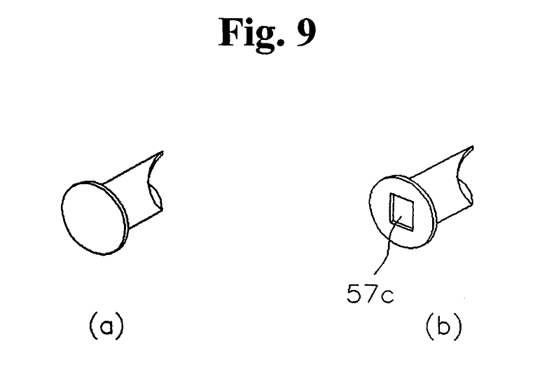

Furthermore, although the longitudinal end of the flange 57b of the shaft 57 is formed smoothly in this embodiment, it may be formed with a recess for an assembly tool as shown in FIG. 9 contrary to this embodiment.

FIGS. 9(a) and (b) show only the longitudinal end of the flange 57b. FIG. 9(a) shows the longitudinal end of the flange 57b of FIG. 6; and FIG. 9(b) shows another embodiment of the flange 57b of FIG. 6 in which a recess for an assembly tool 57c is formed. The flange 57b of FIG. 9(b) is constructed to adapt to assembly automation when the shaft 57 is engaged with the rotating cam 51 using assembly equipment by a manufacturer. The assembly can be performed by inserting the assembly tool into the recess 57c.

Instead of the rectangular recess for the assembly tool 57c shown in FIG. 9(b), a cross-shaped, threaded recess or a hexagonal wrench-shaped recess may be formed.

As described above, the hinge apparatus according to the present invention is constructed such that the rotation cam 51 can be secured to the shaft 57 by forming the engagement protrusions 57a at the one longitudinal end of the shaft 57 and forming the engagement passages 51a and the engagement grooves 51b in the rotating cam 51. Accordingly, the hinge apparatus according to the present invention has an advantage in that there is no need for the securing pin 41 and thus the number of parts can be reduced contrary to the conventional hinge apparatus. Furthermore, the hinge apparatus according to the present invention has further advantages in that since the number of parts is reduced, the number of assembly processes can be reduced, the assembility can be enhanced, and the manufacture costs can be lowered.

Such a hinge apparatus is very usefully employed in a cover opening and closing structure for electronic products having relatively small sizes, such as a cellular phone, a notebook computer, and the like.

* Reference numerals for designating main components in the drawings

1: Cover

3: Body

11, 31, 51: Rotating cam

13, 33, 53: Secured cam

17,37, 55: Spring

19, 39, 57: Shaft

51a: Engagement passage

51b: Engagement groove

57a, 57a: Engagement protrusion

57b: Flange

57c: Recess for assembly tool

1. A hinge apparatus using interaction between a rotating cam 51 with peak portions 51c and valley portions 51d formed therein, and a secured cam 53 formed to be engaged with the rotating cam 51, comprising:
a shaft 57 having a flange 57b formed at one longitudinal end thereof and engagement protrusions 57a formed to protrude from the circumference of the shaft at the other longitudinal end thereof;
the rotating cam 51 having a hollow for allowing penetration of the shaft 57 therethrough, engagement passages 51a formed in the hollow for allowing the engagement protrusions 57a to pass through the engagement passages upon insertion of the shaft 57 into the hollow, and engagement grooves 51b formed at an angle with respect to the engagement passages 51a so that the engagement protrusions 57a of the inserted shaft 57 can be seated therein;
the secured cam 53 being constructed to be engaged with the rotating cam 51 and having a hollow and engagement passages formed to allow the shaft 57 and the engagement protrusions 57a to pass therethrough; and
a spring 55 formed at a trailing end of the secured cam 53 for exerting force so that the rotating cam 51 and the secured cam 53 can be firmly engaged with each other.

2. The hinge apparatus as claimed in claim 1, wherein the flange 57b of the shaft 57 is formed with a recess for an assembly tool 57c for adapting to assembly automation upon securing of the rotating cam 51 to the shaft 57 and for allowing the assembly tool to be inserted thereinto for facilitating rotation of the shaft 57.
